(19) United States
(12) Patent Application Publication
(10) Pub. No.: US 2026/0142421 A1
(43) Pub. Date: May 21, 2026

(54) CONNECTOR ASSEMBLY WITH IMPROVED TONGUE PLATE FOR PROTECTING CONDUCTIVE TERMINALS

(71) Applicant: DONGGUAN LUXSHARE TECHNOLOGIES CO., LTD, Dongguan City (CN)

(72) Inventors: Tengfang XIONG, Dongguan City (CN); Bin HUANG, Dongguan City (CN); Jie ZHANG, Dongguan City (CN); Kunlin YAO, Dongguan City (CN); Hongji CHEN, Dongguan City (CN); Chenhui ZENG, Dongguan City (CN); Shuangfeng YUAN, Dongguan City (CN)

(73) Assignee: DONGGUAN LUXSHARE TECHNOLOGIES CO., LTD, Dongguan City (CN)

(21) Appl. No.: 19/239,158

(22) Filed: Jun. 16, 2025

(30) Foreign Application Priority Data
Nov. 20, 2024 (CN) 202411670367.4

(51) Int. Cl. H01R 13/642; H01R 13/04; H01R 13/633; H01R 13/6461; H01R 13/6591

(52) U.S. Cl. CPC H01R 13/642; H01R 13/04; H01R 13/633; H01R 13/6461; H01R 13/65914

(57) ABSTRACT

A connector assembly includes an electrical connector and a mating module. The electrical connector includes a housing, a first conductive terminal and second a conductive terminal. The first conductive terminal includes a first contact portion. The second conductive terminal includes a second contact portion. The mating module is provided with a tongue plate. The tongue plate includes a base portion, a transition portion and a constriction portion. The constriction portion is configured to be inserted between the first contact portion and the second contact portion. The first contact portion and the second contact portion are configured to be extruded by the mating module along the transition portion to elastically deform outward. The first contact portion and the second contact portion are configured to cross the transition portion to be in contact with the mating module for achieving electrical connection.

### CROSS-REFERENCE TO RELATED APPLICATION

This patent application claims priority of a Chinese Patent Application No. 202411670367.4, filed on Nov. 20, 2024 and titled “CONNECTOR ASSEMBLY”, the entire content of which is incorporated herein by reference.

### TECHNICAL FIELD

The present disclosure relates to a connector assembly, which belongs to the technical field of connectors.

### BACKGROUND

An electrical connector in the related art includes an insulating body, a plurality of conductive terminals mounted to the insulating body, and a metal shell installed on the insulating body. The plurality of conductive terminals include a plurality of signal terminals. Each conductive terminal includes an elastic contact arm. The elastic contact arm includes a contact portion and a tail portion integrally extending from the contact portion. However, as the requirements for signal transmission quality of electrical connectors continue to increase, the tail portion will produce significant resonance if it is long in size.

Besides, shortening the tail portion may easily cause foreign objects to be inserted into the tail portion, thereby reducing the reliability of the electrical connector.

Therefore, there is still room for improvement in electrical connectors in the related art.

### SUMMARY

An object of the present disclosure is to provide a connector assembly.

The present disclosure adopts the following technical solution: a connector assembly, including: an electrical connector, the electrical connector including: a housing, the housing defining a receiving slot extending along a first direction; a first terminal module, the first terminal module being at least partially disposed on the housing; the first terminal module including a plurality of first conductive terminals; each first conductive terminal including a first elastic contact arm; the first elastic contact arm including a first contact portion protruding into the receiving slot; and a second terminal module, the second terminal module being at least partially disposed on the housing; the second terminal module including a plurality of second conductive terminals; each second conductive terminal including a second elastic contact arm; the second elastic contact arm including a second contact portion protruding into the receiving slot; the first contact portion and the second contact portion being located on opposite sides of the receiving slot, respectively, along a second direction perpendicular to the first direction; and a mating module, the mating module including a tongue plate, a plurality of first contact pads located on one side of the tongue plate, and a plurality of second contact pads located on another side of the tongue plate; the tongue plate including a base portion, a transition portion connected to the base portion and a constriction portion connected to the transition portion; a thickness of the constriction portion along the second direction being smaller than a thickness of the base portion along the second direction; the transition portion including a first guide surface and a second guide surface; wherein when the mating module is inserted into the receiving slot, the constriction portion is configured to be inserted between the first contact portion and the second contact portion; the first contact portion and the second contact portion are configured to be extruded by the mating module along the first guide surface and the second guide surface, respectively, to elastically deform outward; the first contact portion and the second contact portion are configured to cross the first guide surface and the second guide surface, respectively, so as to be in contact with the first contact pad and the second contact pad, respectively, for achieving electrical connection.

The present disclosure adopts the following technical solution: a connector assembly, including: an electrical connector, including: a housing defining a receiving slot extending along a first direction; a first terminal module being at least partially mounted to the housing; the first terminal module including a plurality of first conductive terminals; each first conductive terminal including a first elastic contact arm; the first elastic contact arm including a first contact portion protruding into the receiving slot; and a second terminal module being at least partially mounted to the housing; the second terminal module including a plurality of second conductive terminals; each second conductive terminal including a second elastic contact arm; the second elastic contact arm including a second contact portion protruding into the receiving slot; the first contact portion and the second contact portion being located on opposite sides of the receiving slot, respectively, along a second direction perpendicular to the first direction; and a mating module including a tongue plate, a plurality of first contact pads located on one side of the tongue plate, and a plurality of second contact pads located on another side of the tongue plate; the tongue plate including a base portion, a constriction portion and a transition portion smoothly connected between the base portion and the constriction portion; a thickness of the constriction portion along the second direction being smaller than a thickness of the base portion along the second direction; the transition portion including a first guide surface and a second guide surface; wherein when the mating module is inserted into the receiving slot, the constriction portion is configured to be inserted between and clamped by the first contact portion and the second contact portion; the first contact portion and the second contact portion are then extruded by the mating module along the first guide surface and the second guide surface, respectively, to elastically deform outward along the second direction; the first contact portion and the second contact portion then cross the first guide surface and the second guide surface, respectively, so as to be in electrical contact with the first contact pad and the second contact pad, respectively.

### BRIEF DESCRIPTION OF DRAWINGS

FIG. 1 is a schematic perspective view of a connector assembly in accordance with an embodiment of the present disclosure, in which a mating module is inserted into an electrical connector;

FIG. 2 is a partially exploded perspective view of FIG. 1, in which the mating module and the electrical connector are separated from each other;

FIG. 3 is a partially exploded perspective view of FIG. 2 from another angle;

FIG. 4 is a right side view of FIG. 2;

FIG. 5 is a partially exploded perspective view of the electrical connector in FIG. 1, in which a first module, a second module and an outer insulating housing are separated from one another;

FIG. 6 is a top view of the first module and the second module when they are separated from each other;

FIG. 7 is a bottom view of FIG. 6;

FIG. 8 is a partially exploded perspective view of the first module;

FIG. 9 is a partially exploded perspective view of the second module;

FIG. 10 is an exploded perspective view of a first housing, a first insulating block and a first ground sheet in FIG. 8 from another angle;

FIG. 11 is an exploded perspective view of a second housing, a second insulating block and a second ground sheet in FIG. 9 from another angle;

FIG. 12 is a schematic cross-sectional view of the connector assembly of the present disclosure taken along line E-E in FIG. 1, in which the mating module has just been inserted into a receiving slot;

FIG. 13 is a schematic cross-sectional view of the mating module in FIG. 12 when it is further inserted;

FIG. 14 is a schematic cross-sectional view of the mating module in FIG. 13 when it is inserted in place;

FIG. 15 is a partial enlarged view of frame portion B in FIG. 12;

FIG. 16 is a partial enlarged view of frame portion C in FIG. 13; and

FIG. 17 is a partial enlarged view of frame portion D in FIG. 15.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

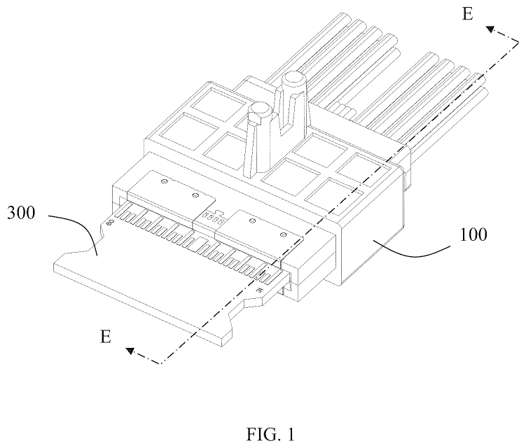

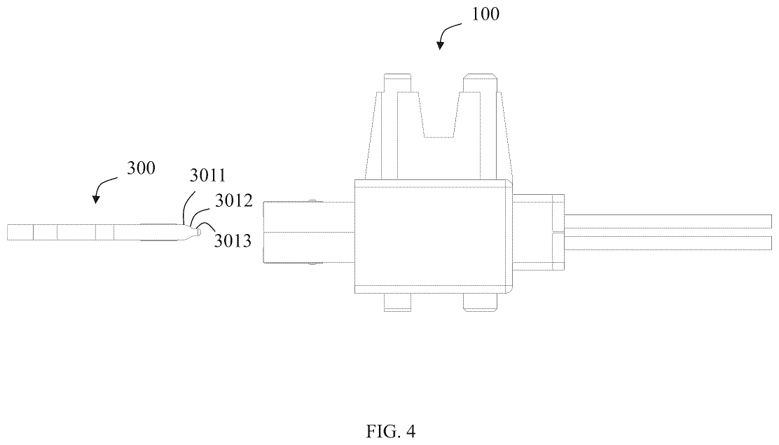

Referring to FIG. 1 to FIG. 4, the present disclosure discloses a connector assembly including an electrical connector 100 and a mating module 300 configured to be at least partially inserted into the electrical connector 100. In the illustrated embodiment of the present disclosure, the electrical connector 100 is an OSFP (Octal Small Form-factor Pluggable) receptacle connector. More specifically, in the illustrated embodiment of the present disclosure, the electrical connector 100 is a receptacle cable connector. Correspondingly, the mating module 300 is an OSFP plug connector. Of course, it is understandable to those skilled in the art that the electrical connector 100 can also be an SFP (Small Form-factor Pluggable) receptacle connector, a QSFP (Quad Small Form-factor Pluggable) receptacle connector, a QSFP-DD (Quad Small Form-factor Pluggable-Double Density) receptacle connector, an SFP-DD (Small Form-factor Pluggable-Double Density) receptacle connector or a DSFP (Dual Chanel Small Form-factor Pluggable) receptacle connector, etc. Correspondingly, the mating module 300 is an SFP plug connector, a QSFP plug connector, a QSFP-DD plug connector, an SFP-DD plug connector or a DSFP plug connector, etc. It is understandable to those skilled in the art that the basic structure of the above types of the electrical connectors 100 is regulated by corresponding association standards, and will not be described in detail here.

In the illustrated embodiment of the present disclosure, the electrical connector 100 defines a receiving slot 101 for at least partially receiving the mating module 300. To simplify the description of the specific embodiments of the present disclosure, an insertion and extraction direction of the mating module 300 and the electrical connector 100 is a first direction A1-A1 (for example, a front-rear direction); a thickness direction of the receiving slot 101 is a second direction A2-A2 (for example, a top-bottom direction); a width direction of the receiving slot 101 is a third direction A3-A3 (for example, a left-right direction). Each two of the first direction A1-A1, the second direction A2-A2 and the third direction A3-A3 are perpendicular to each other.

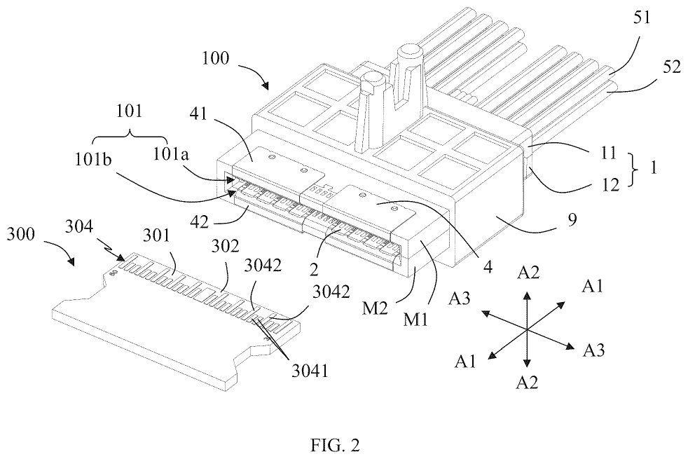

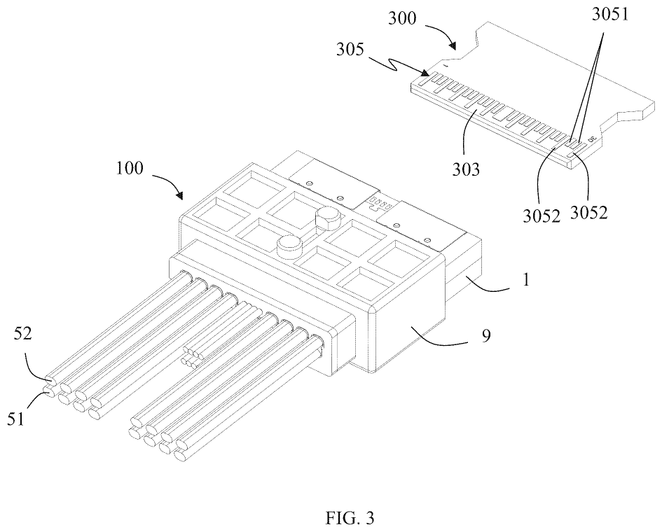

As shown in FIG. 2 and FIG. 3, the mating module 300 includes a tongue plate 301. The tongue plate 301 includes a tongue plate upper surface 302, a tongue plate lower surface 303, a plurality of first contact pads 304 exposed to the tongue plate upper surface 302, and a plurality of second contact pads 305 exposed to the tongue plate lower surface 303. The plurality of first contact pads 304 are disposed at intervals along the third direction A3-A3. The plurality of second contact pads 305 are disposed at intervals along the third direction A3-A3.

Specifically, in the illustrated embodiment of the present disclosure, the plurality of first contact pads 304 include a plurality of first signal contact pads 3041 and a plurality of first ground contact pads 3042. The plurality of first signal contact pads 3041 are divided into a plurality of groups, in which each group includes two first signal contact pads 3041 adjacently arranged along the third direction A3-A3. Each group of first signal contact pads 3041 is associated with two first ground contact pads 3042 which are located on two sides thereof respectively, so as to improve shielding and improve signal transmission quality. In the illustrated embodiment of the present disclosure, each group of first signal contact pads 3041 forms a differential pair to increase the speed of signal transmission. In the illustrated embodiment of the present disclosure, a length of each first ground contact pad 3042 along the first direction A1-A1 is greater than a length of each first signal contact pad 3041 along the first direction A1-A1, so as to better improve the shielding and improve the signal transmission quality.

Similarly, in the illustrated embodiment of the present disclosure, the plurality of second contact pads 305 include a plurality of second signal contact pads 3051 and a plurality of second ground contact pads 3052. The plurality of second signal contact pads 3051 are divided into a plurality of groups, in which each group includes two second signal contact pads 3051 adjacently arranged along the third direction A3-A3. Each group of second signal contact pads 3051 is associated with two second ground contact pads 3052 which are located on two sides thereof respectively, so as to improve shielding and improve signal transmission quality. In the illustrated embodiment of the present disclosure, each group of second signal contact pads 3051 forms a differential pair to increase the speed of signal transmission. In the illustrated embodiment of the present disclosure, a length of each second ground contact pad 3052 along the first direction A1-A1 is greater than a length of each second signal contact pad 3051 along the first direction A1-A1, so as to better improve the shielding and improve the signal transmission quality.

In the illustrated embodiment of the present disclosure, the tongue plate 301 includes a base portion 3011, a transition portion 3012 connected to the base portion 3011, and a constriction portion 3013 connected to the transition portion 3012. The base portion 3011, the transition portion 3012 and the constriction portion 3013 are arranged sequentially along the first direction A1-A1. A thickness of the constriction portion 3013 along the second direction A2-A2 is smaller than a thickness of the base portion 3011 along the second direction A2-A2.

Specifically, in the illustrated embodiment of the present disclosure, the constriction portion 3013 includes a first flat surface 3013a and a second flat surface 3013b disposed opposite to the first flat surface 3013a along the second direction A2-A2. The base portion 3011 includes a third flat surface 3011a and a fourth flat surface 3011b disposed opposite to the third flat surface 3011a along the second direction A2-A2. The transition portion 3012 includes a first guide surface 3012a and a second guide surface 3012b. The first guide surface 3012a connects the first flat surface 3013a and the third flat surface 3011a. The second guide surface 3012b connects the second flat surface 3013b and the fourth flat surface 3011b.

In the illustrated embodiment of the present disclosure, the first guide surface 3012a smoothly connects the first flat surface 3013a and the third flat surface 3011a. The second guide surface 3012b smoothly connects the second flat surface 3013b and the fourth flat surface 3011b. Specifically, an arc is used for transition between the first guide surface 3012a and the first flat surface 3013a. An arc is used for transition between the first guide surface 3012a and the third flat surface 3011a. An arc is used for transition between the second guide surface 3012b and the second flat surface 3013b. An arc is used for transition between the second guide surface 3012b and the fourth flat surface 3011b.

A distance between the third flat surface 3011a and the fourth flat surface 3011b along the second direction A2-A2 is greater than a distance between the first flat surface 3013a and the second flat surface 3013b along the second direction A2-A2.

Besides, the contraction portion 3013 includes a first guide inclined surface 3013c and a second guide inclined surface 3013d which are located at an end of the contraction portion 3013.

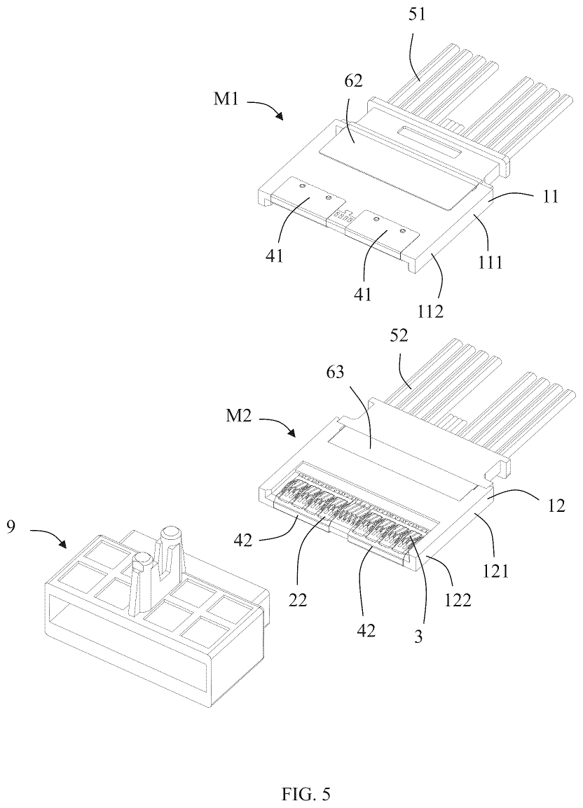

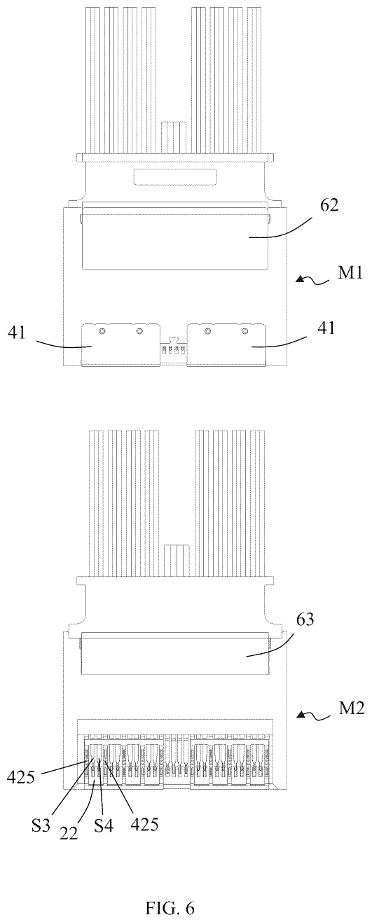

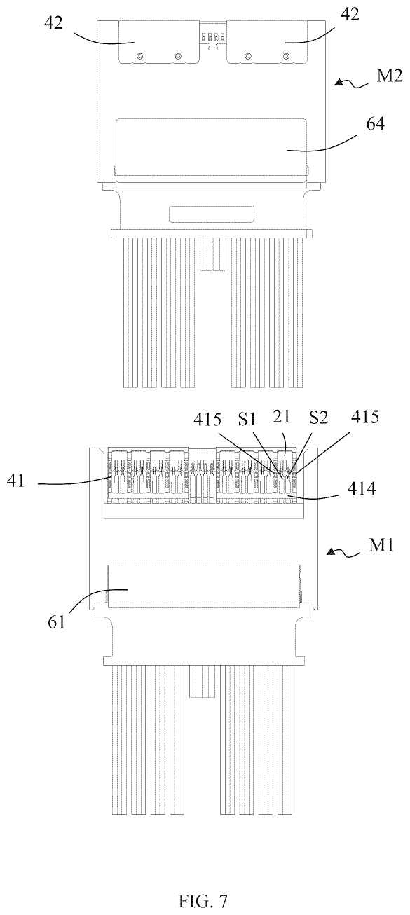

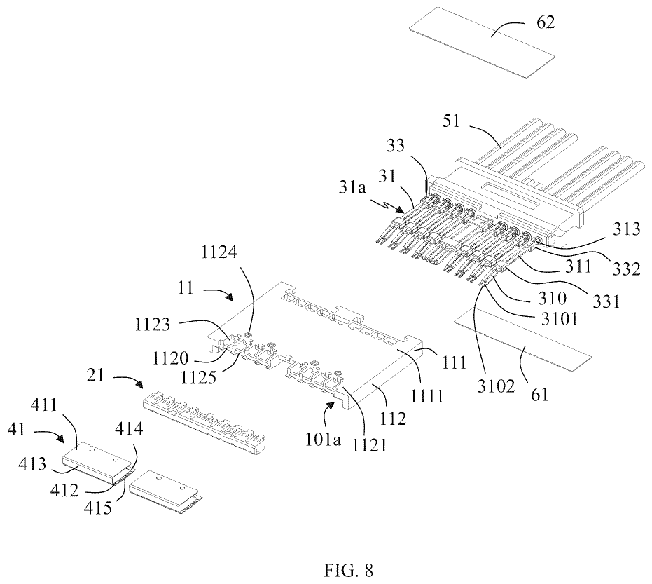

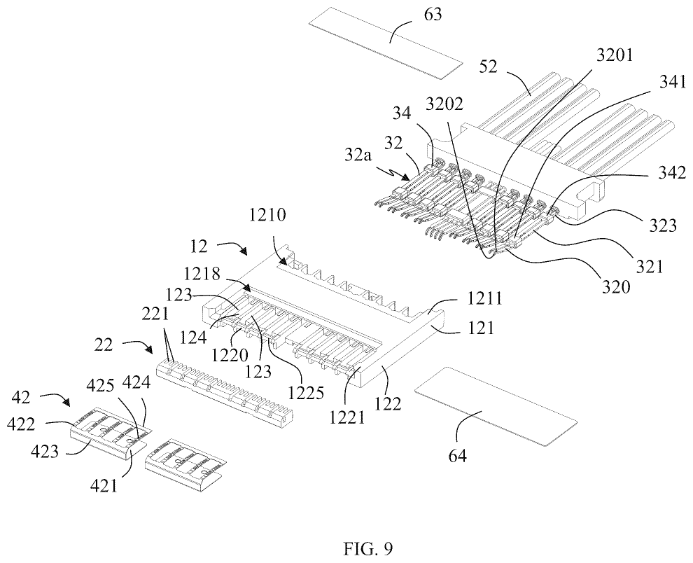

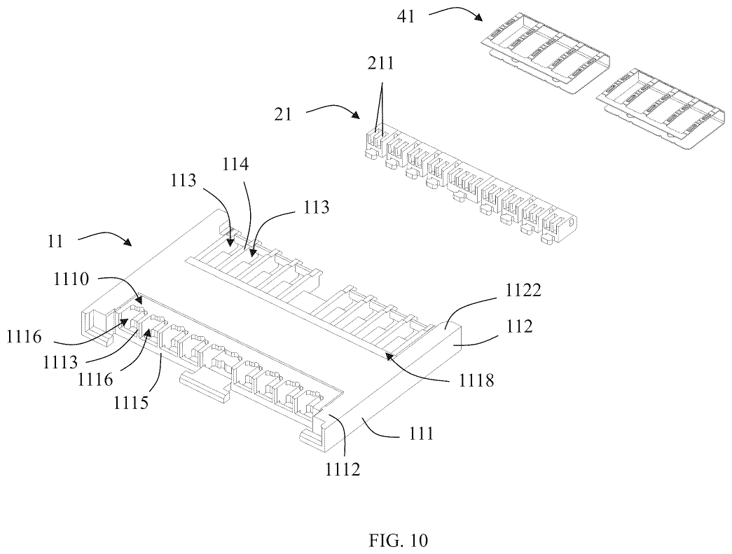

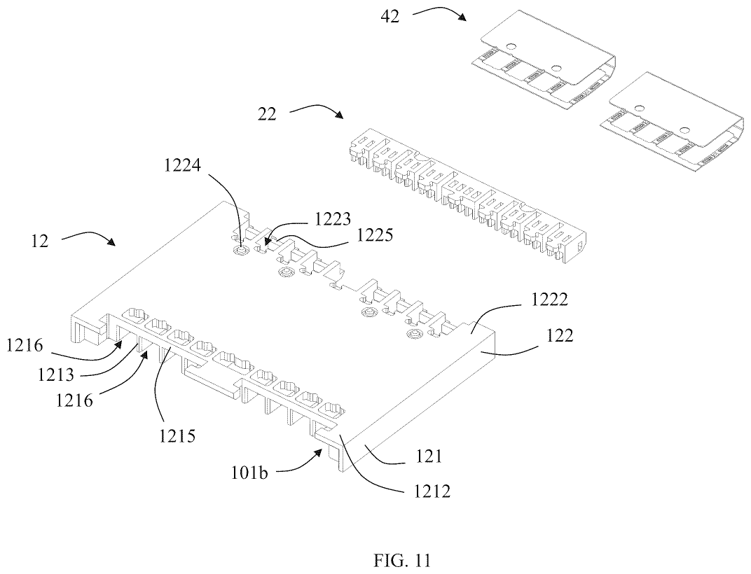

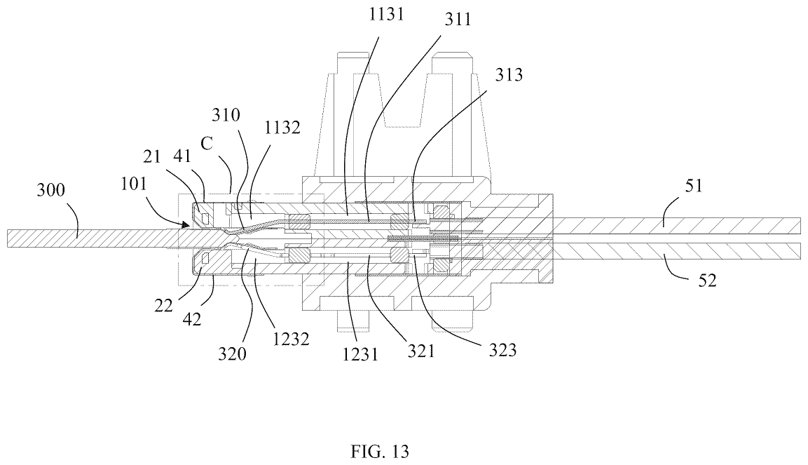

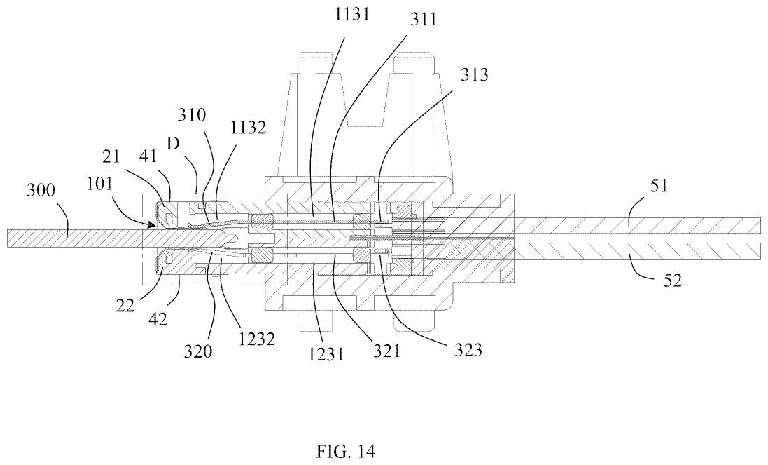

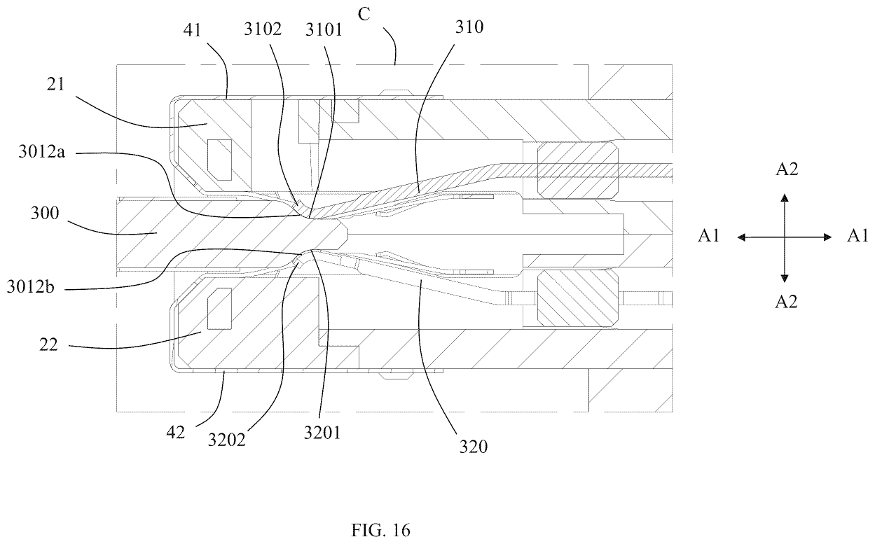

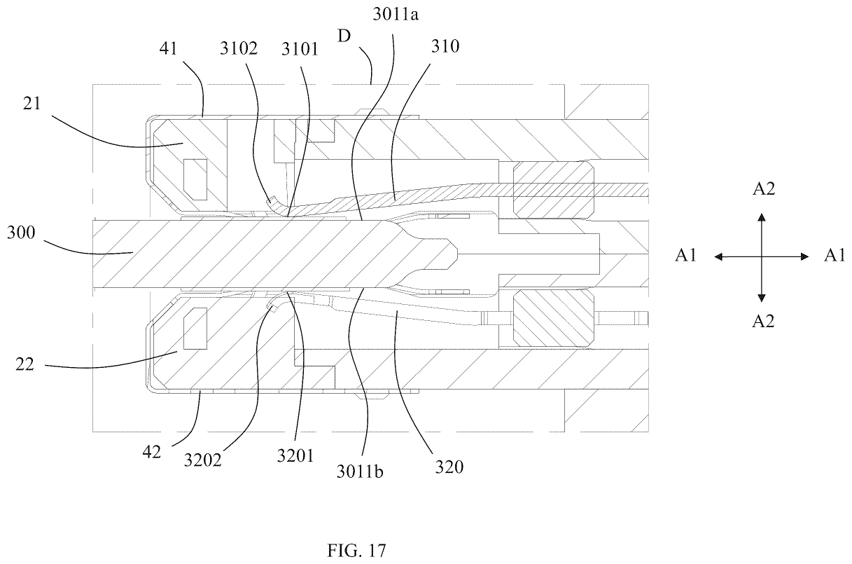

Referring to FIG. 5 to FIG. 17, in the illustrated embodiment of the present disclosure, the electrical connector 100 includes a first module M1, a second module M2 and an outer insulating housing 9 fixed on the first module M1 and the second module M2. The first module M1 and the second module M2 are separately arranged and fixed together.

In one embodiment of the present disclosure, the electrical connector 100 includes a housing 1, a terminal protection device 8 mounted to the housing 1, and a plurality of conductive terminals 3 mounted to the housing 1.

In an embodiment of the present disclosure, the housing 1 is a conductive housing. The conductive housing is a metal housing made of metal material so as to further improve the shielding effect and improve the quality of signal transmission. In another embodiment of the present disclosure, the conductive housing may also be a composite housing formed by electroplating a metal material on an insulating material. The composite housing can also improve the shielding effect and improve the quality of signal transmission.

In an embodiment of the present disclosure, the housing 1 includes a first housing 11 and a second housing 12. The first housing 11 is a first conductive housing, and the second housing 12 is a second conductive housing. The first housing 11 and the second housing 12 are fixed together. For example, after the first housing 11 and the second housing 12 are assembled, they are fixed together for example by welding or soldering or other methods. In the illustrated embodiment of the present disclosure, the first housing 11 of the first module M1 and the second housing 12 of the second module M2 are separately arranged and fixed together to jointly form the receiving slot 101.

In an embodiment of the present disclosure, the first housing 11 includes a first base portion 111 and a first protruding portion 112 extending forwardly from the first base portion 111. In the illustrated embodiment of the present disclosure, the first base portion 111 and the first protruding portion 112 have the same width. The first base portion 111 includes a first upper surface 1111, a first lower surface 1112, a first rear surface 1115 and a plurality of first mounting grooves 1116 recessed forwardly from the first rear surface 1115. The plurality of first mounting grooves 1116 are spaced apart along the third direction A3-A3. Besides, the plurality of first mounting grooves 1116 extend downwardly through the first lower surface 1112. In the illustrated embodiment of the present disclosure, the first base portion 111 is further provided with a plurality of first barrier portions 1113. Any two adjacent first mounting grooves 1116 are separated by one first barrier portion 1113 located between the two first mounting grooves 1116 so as to improve the shielding effect and improve the quality of signal transmission. The first base portion 111 further defines a first mounting recess 1110 formed upwardly from the first lower surface 1112. Specifically, in the illustrated embodiment of the present disclosure, the first mounting grooves 1116 extend backwardly through the first rear surface 1115. The first mounting grooves 1116 communicate downwardly with the first mounting recess 1110. Besides, a bottom of the first base portion 111 further includes at least one first recess 1118 adjacent to the first protruding portion 112.

The first protruding portion 112 includes a second upper surface 1121, a second lower surface 1122, and a plurality of first mounting openings 1123 extending upwardly through the second upper surface 1121 along the second direction A2-A2. The first mounting opening 1123 does not completely extend forwardly through the first front end surface 1120 of the first protruding portion 112 along the first direction A1-A1. In other words, the first protruding portion 112 is provided with a first beam portion 1125 located at a front end of the first mounting opening 1123 to improve the structural strength of the first protruding portion 112. An upper surface of the first beam portion 1125 is lower than the second upper surface 1121 of the first protruding portion 112. The first protruding portion 112 further includes a plurality of first positioning posts 1124 protruding upwardly from the second upper surface 1121 along the second direction A2-A2. In addition, the first housing 11 further includes a first receiving slot 101a extending through the first front end surface 1120 along the first direction A1-A1. The first mounting opening 1123 is in communication with the first receiving slot 101a. The first receiving slot 101a is configured to at least partially receive the mating module 300.

In the illustrated embodiment of the present disclosure, the first housing 11 further includes a plurality of first terminal module accommodating slots 113 extending along the first direction A1-A1. The first mounting opening 1123 is located at one end (for example, a front end) of the first terminal module accommodating slot 113. Each first terminal module accommodating slot 113 extends from a portion of the first base portion 111 to the first protruding portion 112. A rear end of the first terminal module accommodating slot 113 communicates with the first mounting groove 1116. A middle portion of the first terminal module accommodating slot 113 is circumferentially surrounded by walls of the first housing 11. A front end of the first terminal module accommodating slot 113 extends downwardly through the second lower surface 1122. Specifically, in the illustrated embodiment of the present disclosure, the first terminal module accommodating slot 113 includes a first surrounding groove 1131 close to a corresponding first mounting groove 1116 and a first open slot 1132 away from the corresponding first mounting groove 1116. The first surrounding groove 1131 is surrounded by wall portions of the first housing 11 along a circumferential direction. The first open slot 1132 communicates with the receiving slot 101. It is understandable to those skilled in the art that by arranging the middle portion of the first terminal module accommodating slot 113 to be surrounded by the wall portions of the first housing 11 in a circumferential direction, on the one hand, the conductive terminals located in the first terminal module accommodating slots 113 can be better shielded; and on the other hand, adjacent first terminal module accommodating slots 113 can be well separated, thereby reducing signal crosstalk.

The plurality of first terminal module accommodating slots 113 are spaced apart along the third direction A3-A3. The first housing 11 includes a plurality of first partition walls 114 disposed at intervals along the third direction A3-A3. Two adjacent first terminal module accommodating slots 113 are separated by a corresponding first partition wall 114 along the third direction A3-A3. In other words, each first terminal module accommodating slot 113 is surrounded by four walls of the first housing 11 on a length corresponding to the corresponding first partition wall 114, thereby improving the shielding effect. With this arrangement, each first terminal module accommodating slot 113 is relatively independent, thereby reducing signal crosstalk and improving the quality of data transmission.

The first module M1 further includes a first insulating block 21 fixed in the first mounting opening 1123. The first insulating block 21 defines a plurality of first slits 211.

In an embodiment of the present disclosure, the second housing 12 includes a second base portion 121 and a second protruding portion 122 extending forwardly from the second base portion 121. The second base portion 121 includes a third upper surface 1211, a third lower surface 1212, a second rear surface 1215 and a plurality of second mounting grooves 1216 recessed forwardly from the second rear surface 1215. The plurality of second mounting grooves 1216 are spaced apart along the third direction A3-A3. The plurality of second mounting grooves 1216 extend through the second base portion 121 along the top-bottom direction. The plurality of second mounting grooves 1216 extend upwardly through the third upper surface 1211. In the illustrated embodiment of the present disclosure, the second base portion 121 is further provided with a plurality of second barrier portions 1213. Any two adjacent second mounting grooves 1216 are separated by one second barrier portion 1213 located between the two second mounting grooves 1216 to improve the shielding effect and improve the quality of signal transmission. The second base portion 121 further defines a second mounting recess 1210 formed downwardly from the third upper surface 1211. Specifically, in the illustrated embodiment of the present disclosure, the second mounting grooves 1216 extend backwardly through the second rear surface 1215. The second mounting grooves 1216 upwardly communicate with the second mounting recess 1210. The second mounting recess 1210 extends upwardly through the third upper surface 1211. Besides, a top of the second base portion 121 further defines at least one second recess 1218 adjacent to the second protruding portion 122.

The second protruding portion 122 includes a fourth upper surface 1221, a fourth lower surface 1222, and a plurality of second mounting openings 1223 extending downwardly through the fourth lower surface 1222. The second mounting opening 1223 does not completely extend forwardly through the second front end surface 1220 of the second protruding portion 122. In other words, the second protruding portion 122 is provided with a second beam portion 1225 located at a front end of the second mounting opening 1223 to improve the structural strength of the second protruding portion 122. A lower surface of the second beam portion 1225 is higher than the fourth lower surface 1222 of the second protruding portion 122. The second protruding portion 122 further includes a plurality of second positioning posts 1224 protruding downwardly from the second lower surface 1122. In addition, the second housing 12 further includes a second receiving slot 101b extending through the second front end surface 1220 along the first direction A1-A1. The second mounting opening 1223 is in communication with the second receiving slot 101b. The second receiving slot 101b is configured to at least partially receive the mating module 300.

In the illustrated embodiment of the present disclosure, the second housing 12 further includes a plurality of second terminal module accommodating slots 123 extending along the first direction A1-A1. The second mounting opening 1223 is located at one end (for example, a front end) of the second terminal module accommodating slot 123. Each second terminal module accommodating slot 123 extends from the second base portion 121 to the second protruding portion 122. A rear end of the second terminal module accommodating slot 123 communicates with the second mounting groove 1216. The middle portion of the second terminal module accommodating slot 123 is circumferentially surrounded by walls of the second housing 12. A front end of the second terminal module accommodating slot 123 extends upwardly through the fourth upper surface 1221. Specifically, in the illustrated embodiment of the present disclosure, the second terminal module accommodating slot 123 includes a second surrounding groove 1231 close to a corresponding second mounting groove 1216 and a second open slot 1232 away from the corresponding second mounting groove 1216. The second surrounding groove 1231 is surrounded by wall portions of the second housing 12 along a circumferential direction. The second open slot 1232 communicates with the receiving slot 101. It is understandable to those skilled in the art that by arranging the middle portion of the second terminal module accommodating slot 123 to be surrounded by the wall portions of the second housing 12 in a circumferential direction; on the one hand, the conductive terminals located in the second terminal module accommodating slots 123 can be better shielded; and on the other hand, the adjacent second terminal module accommodating slots 123 can be well separated, thereby reducing signal crosstalk.

The plurality of second terminal module accommodating slots 123 are arranged at intervals along the third direction A3-A3. The second housing 12 includes a plurality of second partition walls 124 disposed at intervals along the third direction A3-A3. Two adjacent second terminal module accommodating slots 123 are separated by corresponding second partition walls 124 along the third direction A3-A3. In other words, each second terminal module accommodating slot 123 is surrounded by four walls of the second housing 12 on a length corresponding to the second partition wall 124, thereby improving the shielding effect. With this arrangement, each second terminal module accommodating slot 123 is relatively independent, thereby reducing signal crosstalk and improving the quality of data transmission.

The second module M2 further includes a second insulating block 22 fixed in the second mounting opening 1223. The second insulating block 22 defines a plurality of second slits 221.

The plurality of conductive terminals 3 include a plurality of first conductive terminals 31 and a plurality of second conductive terminals 32. Each first conductive terminal 31 includes a first fixing portion 311 extending along the first direction A1-A1, a first elastic contact arm 310 extending forwardly from a front end of the first fixing portion 311, and a first tail portion 313 extending backwardly from a rear end of the first fixing portion 311. The first fixing portion 311 is at least partially located in the first surrounding groove 1131. The first elastic contact arm 310 is at least partially located in the first open slot 1132. The first tail portion 313 is at least partially located in the first mounting groove 1116. The first elastic contact arm 310 includes a first contact portion 3101 that passes through the first open slot 1132 and extends into the first receiving slot 101a. The first contact portions 3101 are configured to be in contact with the first signal contact pads 3041 of the tongue plate 301. In the illustrated embodiment of the present disclosure, the first tail portions 313 extend backwardly and horizontally to be electrically connected to first cables 51. In addition, the first elastic contact arm 310 further includes a first distal end portion 3102 extending from the first contact portion 3101. The first distal end portion 3102 of the first conductive terminal 31 is received in the first slit 211 when the first elastic contact arm 310 is elastically deformed. In the illustrated embodiment of the present disclosure, a length of the first distal end portion 3102 is short in order to improve resonance and improve the quality of signal transmission.

In the illustrated embodiment of the present disclosure, the plurality of first conductive terminals 31 are divided into a plurality of groups. Each group of first conductive terminals 31 includes a first signal terminal S1 and a second signal terminal S2 located adjacent to the first signal terminal S1. Preferably, the first signal terminal S1 and the second signal terminal S2 in each group of first conductive terminals 31 form a differential pair to improve signal transmission speed, thereby being suitable for high-speed signal transmission.

In the illustrated embodiment of the present disclosure, the electrical connector 100 further includes a first holding block 33 fixed on the first signal terminal S1 and the second signal terminal S2 of each group of first conductive terminals 31. In an embodiment of the present disclosure, the first signal terminal S1 and the second signal terminal S2 are insert-molded with the first holding block 33, so as to form an integrated first terminal module 31a. The first contact portions 3101 of the first signal terminal S1 and the second signal terminal S2 in each first terminal module 31a are configured to be in contact with the first signal contact pads 3041 of the mating module 300, respectively. The first terminal module 31a is at least partially disposed (for example, assembled) in the first terminal module accommodating slot 113.

In the illustrated embodiment of the present disclosure, the first holding block 33 includes a first fixing block 331 fixed on middle portions of the first fixing portions 311 of the first signal terminal S1 and the second signal terminal S2, and a second fixing block 332 fixed on rear ends of the first fixing portions 311 of the first signal terminal S1 and the second signal terminal S2. The first fixing block 331 and the second fixing block 332 are installed and fixed in the first terminal module accommodating slot 113, which prevents the first conductive terminal 31 from contacting the first housing 11 to cause a short circuit. The first tail portion 313 extends backwardly into the first mounting groove 1116 to facilitate connection with the first cable 51.

Similarly, each second conductive terminal 32 includes a second fixing portion 321 extending along the first direction A1-A1, a second elastic contact arm 320 extending forwardly from a front end of the second fixing portion 321, and a second tail portion 323 extending backwardly from a rear end of the second fixing portion 321. The second fixing portion 321 is at least partially located in the second surrounding groove 1231. The second elastic contact arm 320 is located at least partially in the second open slot 1232. The second tail portion 323 is at least partially located in the second mounting groove 1216. The second elastic contact arm 320 includes a second contact portion 3201 that passes through the second open slot 1232 and extends into the second receiving slot 101b. The second contact portions 3201 are configured to be in contact with the second signal contact pads 3051 of the tongue plate 301. In the illustrated embodiment of the present disclosure, the second tail portions 323 extend backwardly and horizontally from the second fixing portions 321 to be electrically connected to second cables 52. In addition, the second elastic contact arm 320 further includes a second distal end portion 3202 extending from the second contact portion 3201. The second distal end portion 3202 of the second conductive terminal 32 is received in the second slit 221 when the second elastic contact arm 320 is elastically deformed. In the illustrated embodiment of the present disclosure, a length of the second distal end portion 3202 is short in order to improve resonance and improve the quality of signal transmission. Besides, the provision of the slider 81 reduces the risk that the first distal end portion 3102 and the second distal end portion 3202 are easily damaged by foreign objects after their lengths are shortened, thereby improving reliability.

In the illustrated embodiment of the present disclosure, the plurality of second conductive terminals 32 are divided into a plurality of groups, and each group of second conductive terminals 32 includes a third signal terminal S3 and a fourth signal terminal S4 located adjacent to the third signal terminal S3. Preferably, the third signal terminal S3 and the fourth signal terminal S4 in each group of second conductive terminals 32 form a differential pair to improve signal transmission speed, thereby being suitable for high-speed signal transmission.

In the illustrated embodiment of the present disclosure, the electrical connector 100 further includes a second holding block 34 fixed on the third signal terminal S3 and the fourth signal terminal S4 of each group of second conductive terminals 32. In one embodiment of the present disclosure, the third signal terminal S3 and the fourth signal terminal S4 are insert-molded with the second holding block 34 to form an integrated second terminal module 32a. The second contact portions 3201 of the third signal terminal S3 and the fourth signal terminal S4 in each second terminal module 32a are configured to be in contact with the second signal contact pads 3051 of the mating module 300. The second terminal module 32a is at least partially disposed (for example, assembled) in the second terminal module accommodating slot 123.

In the illustrated embodiment of the present disclosure, the second holding block 34 includes a third fixing block 341 fixed at middle portions of the second fixing portions 321 of the third signal terminal S3 and the fourth signal terminal S4, and a fourth fixing block 342 fixed at rear ends of the second fixing portions 321 of the third signal terminal S3 and the fourth signal terminal S4. The third fixing block 341 and the fourth fixing block 342 are installed and fixed in the second terminal module accommodating slot 123, which prevents the second conductive terminal 32 from contacting the second housing 12 to cause a short circuit. The second tail portions 323 extend backwardly into the second mounting grooves 1216 to facilitate connection with the second cables 52.

In one embodiment of the present disclosure, the electrical connector 100 further includes at least one ground sheet 4 mounted to the housing 1. The ground sheet 4 includes a first ground sheet 41 and a second ground sheet 42. In the illustrated embodiment of the present disclosure, two first ground sheets 41 are provided and they are made of metal material. Two second ground sheets 42 are provided and they are made of metal material.

Each first ground sheet 41 is generally U-shaped and includes a first mounting plate 411, a second mounting plate 412 disposed opposite to the first mounting plate 411, a first connecting plate 413 connecting one side of the first mounting plate 411 and one side of the second mounting plate 412, and a first extension plate 414 extending downwardly and backwardly from another side of the second mounting plate 412. The first mounting plate 411 defines a plurality of first mounting positioning holes 4111 that match the first positioning posts 1124. The first extension plate 414 is received in a corresponding first recess 1118 of the first housing 11.

The first connecting plate 413 is located at a front end of the receiving slot 101 along the first direction A1-A1. When the mating module 300 is inserted, the tongue plate 301 may be in contact with the first connecting plate 413 first, thereby facilitating the discharge of static electricity. The second mounting plate 412 is provided with a plurality of first ground elastic arms 415 which are disposed at intervals along the third direction A3-A3. The first ground elastic arms 415 are disposed on two sides of the first elastic contact arms 310 of each group of first conductive terminals 31 so as to improve the shielding effect and improve the quality of signal transmission.

In an embodiment of the present disclosure, the first positioning posts 1124 are fixed to the first mounting positioning holes 4111, so that the first mounting plate 411 is fixed to the second upper surface 1121 of the first protruding portion 112.

Each second ground sheet 42 is generally U-shaped and includes a third mounting plate 421, a fourth mounting plate 422 opposite to the third mounting plate 421, a second connecting plate 423 connecting one side of the third mounting plate 421 and one side of the fourth mounting plate 422, and a second extension plate 424 extending downwardly and backwardly from another side of the fourth mounting plate 422. The third mounting plate 421 defines a plurality of second mounting positioning holes 4211 that match the second positioning posts 1224. The second extension plate 424 is received in a corresponding second recess 1218 of the second housing 12.

The second connecting plate 423 is located at the front end of the receiving slot 101 along the first direction A1-A1. When the mating module 300 is inserted, the tongue plate 301 may be in contact with the second connecting plate 423 first, thereby facilitating the discharge of static electricity. The fourth mounting plate 422 is provided with a plurality of second ground elastic arms 425 which are disposed at intervals along the third direction A3-A3. The second ground elastic arms 425 are disposed on two sides of the second elastic contact arms 320 of each group of second conductive terminals 32, respectively, so as to improve the shielding effect and improve the quality of signal transmission.

In an embodiment of the present disclosure, the second positioning posts 1224 are fixed in the second mounting positioning holes 4211, so that the third mounting plate 421 is fixed to the fourth lower surface 1222 of the second protruding portion 122.

In the illustrated embodiment of the present disclosure, the first module M1 further includes a first shielding plate 61 installed on the first housing 11 and a first shielding cover 62 installed on the first housing 11. In an embodiment of the present disclosure, the first shielding plate 61 is a metal shielding plate, and the first shielding cover 62 is a metal shielding cover. The first shielding plate 61 is installed in the first mounting recess 1110. By installing the first shielding plate 61, the downwardly open first mounting grooves 1116 can be better shielded, thereby improving the shielding effect.

In the illustrated embodiment of the present disclosure, the second module M2 further includes a second shielding plate 63 installed on the second housing 12 and a second shielding cover 64 installed on the second housing 12. In an embodiment of the present disclosure, the second shielding plate 63 is a metal shielding plate, and the second shielding cover 64 is a metal shielding cover. The second shielding plate 63 is installed in the second mounting recess 1210. By installing the second shielding plate 63, the downwardly open second mounting grooves 1216 can be better shielded, thereby improving the shielding effect.

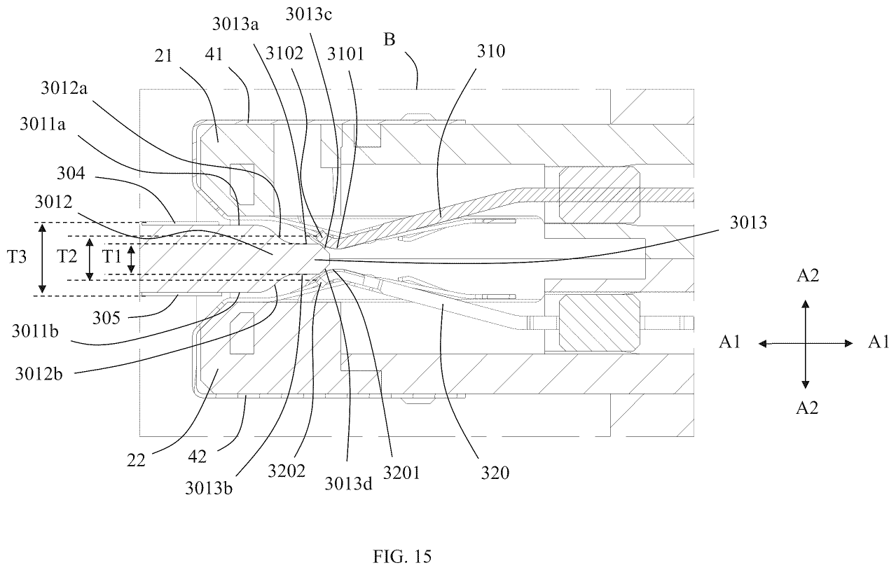

Referring to FIG. 15, in the illustrated embodiment of the present disclosure, after the lengths of the first distal end portion 3102 and the second distal end portion 3202 are shortened, a distance T2 between a lower sharp corner of the first distal end portion 3102 and an upper sharp corner of the second distal end portion 3202 along the second direction A2-A2 is smaller than a thickness T3 of the tongue plate 301 along the second direction A2-A2. Besides, a thickness T1 of the constriction portion 3013 along the second direction A2-A2 is smaller than the distance T2 between the lower sharp corner of the first distal end portion 3102 and the upper sharp corner of the second distal end portion 3202 along the second direction A2-A2.

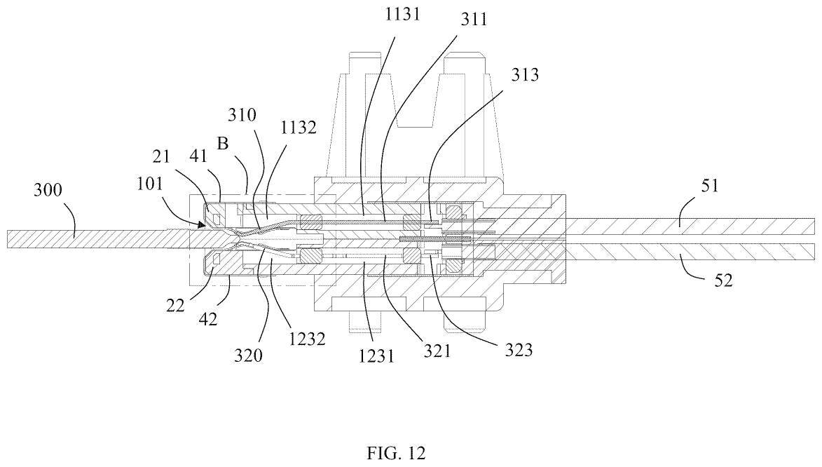

Referring to FIG. 12 to FIG. 17, when in use, when the mating module 300 is inserted into the receiving slot 101, the first guide inclined surface 3013c and the second guide inclined surface 3013d are configured to abut against the first contact portion 3101 and the second contact portion 3201, respectively. The constriction portion 3013 is configured to be inserted between the first contact portion 3101 and the second contact portion 3201. The first contact portion 3101 and the second contact portion 3201 are configured to be pushed by the mating module 300 along the first guide surface 3012a and the second guide surface 3012b respectively to elastically deform outward. The first contact portion 3101 and the second contact portion 3201 are configured to cross the first guide surface 3012a and the second guide surface 3012b, respectively, and be in contact with the first contact pad 304 and the second contact pad 305, respectively, so as to achieve electrical connection. With such an arrangement, on the one hand, the resonance can be improved by shortening the lengths of the first distal end portion 3102 and the second distal end portion 3202, thereby improving the quality of signal transmission. On the other hand, through the optimized design of the mating module 300, when the mating module 300 is inserted into the receiving slot 101, the mating module 300 is able to hierarchically expand the first elastic contact arm 310 and the second elastic contact arm 320 to the outside, which reduces the risk that the first distal end portion 3102 and the second distal end portion 3202 are easily damaged by foreign objects after their lengths are shortened, thereby improving reliability.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A connector assembly, comprising:
an electrical connector, the electrical connector comprising:
a housing, the housing defining a receiving slot extending along a first direction;
a first terminal module, the first terminal module being at least partially disposed on the housing; the first terminal module comprising a plurality of first conductive terminals; each first conductive terminal comprising a first elastic contact arm; the first elastic contact arm comprising a first contact portion protruding into the receiving slot; and
a second terminal module, the second terminal module being at least partially disposed on the housing; the second terminal module comprising a plurality of second conductive terminals; each second conductive terminal comprising a second elastic contact arm; the second elastic contact arm comprising a second contact portion protruding into the receiving slot; the first contact portion and the second contact portion being located on opposite sides of the receiving slot, respectively, along a second direction perpendicular to the first direction; and
a mating module, the mating module comprising a tongue plate, a plurality of first contact pads located on one side of the tongue plate, and a plurality of second contact pads located on another side of the tongue plate; the tongue plate comprising a base portion, a transition portion connected to the base portion and a constriction portion connected to the transition portion; a thickness of the constriction portion along the second direction being smaller than a thickness of the base portion along the second direction; the transition portion comprising a first guide surface and a second guide surface;
wherein when the mating module is configured to be inserted into the receiving slot, the constriction portion is configured to be inserted between the first contact portion and the second contact portion; the first contact portion and the second contact portion are configured to be extruded by the mating module along the first guide surface and the second guide surface, respectively, to elastically deform outward; the first contact portion and the second contact portion are configured to cross the first guide surface and the second guide surface, respectively, so as to be in contact with the first contact pad and the second contact pad, respectively, for achieving electrical connection.

2. The connector assembly according to claim 1, wherein the constriction portion comprises a first flat surface and a second flat surface disposed opposite to the first flat surface along the second direction;
the base portion comprises a third flat surface and a fourth flat surface disposed opposite to the third flat surface along the second direction;
the first guide surface connects the first flat surface and the third flat surface; and the second guide surface connects the second flat surface and the fourth flat surface.

3. The connector assembly according to claim 2, wherein the first guide surface smoothly connects the first flat surface and the third flat surface; the second guide surface smoothly connects the second flat surface and the fourth flat surface.

4. The connector assembly according to claim 3, wherein a first arc is provided and used for transition between the first guide surface and the first flat surface; a second arc is provided and used for transition between the first guide surface and the third flat surface; a third arc is provided and used for transition between the second guide surface and the second flat surface; and a fourth arc is provided and used for transition between the second guide surface and the fourth flat surface.

5. The connector assembly according to claim 2, wherein a distance between the third flat surface and the fourth flat surface along the second direction is greater than a distance between the first flat surface and the second flat surface along the second direction.

6. The connector assembly according to claim 2, wherein the constriction portion comprises a first guide inclined surface and a second guide inclined surface which are disposed at an end of the constriction portion; the first guide inclined surface and the second guide inclined surface are configured to abut against the first contact portion and the second contact portion, respectively.

7. The connector assembly according to claim 1, wherein the housing comprises a first conductive housing and a second conductive housing; the first conductive housing and the second conductive housing are separately arranged and fixed together to jointly form the receiving slot;
the first conductive terminals are not in contact with the first conductive housing; the second conductive terminals are not in contact with the second conductive housing.

8. The connector assembly according to claim 7, wherein the electrical connector further comprises a first ground sheet fixed to the first conductive housing; the first ground sheet comprises a first mounting plate, a second mounting plate disposed opposite to the first mounting plate, and a first connecting plate connecting one side of the first mounting plate and one side of the second mounting plate; the second mounting plate is provided with a first ground elastic arm protruding into the receiving slot and being configured to abut against the mating module.

9. The connector assembly according to claim 7, wherein the electrical connector comprises a second ground plate fixed to the second conductive housing; the second ground plate comprises a third mounting plate, a fourth mounting plate disposed opposite to the third mounting plate, and a second connecting plate connecting one side of the third mounting plate and one side of the fourth mounting plate; the fourth mounting plate is provided with a second ground elastic arm protruding into the receiving slot and being configured to abut against the mating module.

10. The connector assembly according to claim 1, wherein the electrical connector comprises a plurality of first cables connected to the first conductive terminals and a plurality of second cables connected to the second conductive terminals.

11. A connector assembly, comprising:
an electrical connector, comprising:
a housing defining a receiving slot extending along a first direction;
a first terminal module being at least partially mounted to the housing; the first terminal module comprising a plurality of first conductive terminals; each first conductive terminal comprising a first elastic contact arm; the first elastic contact arm comprising a first contact portion protruding into the receiving slot; and
a second terminal module being at least partially mounted to the housing; the second terminal module comprising a plurality of second conductive terminals; each second conductive terminal comprising a second elastic contact arm; the second elastic contact arm comprising a second contact portion protruding into the receiving slot; the first contact portion and the second contact portion being located on opposite sides of the receiving slot, respectively, along a second direction perpendicular to the first direction; and
a mating module comprising a tongue plate, a plurality of first contact pads located on one side of the tongue plate, and a plurality of second contact pads located on another side of the tongue plate; the tongue plate comprising a base portion, a constriction portion and a transition portion smoothly connected between the base portion and the constriction portion; a thickness of the constriction portion along the second direction being smaller than a thickness of the base portion along the second direction; the transition portion comprising a first guide surface and a second guide surface;
wherein when the mating module is configured to be inserted into the receiving slot, the constriction portion is configured to be inserted between and clamped by the first contact portion and the second contact portion; the first contact portion and the second contact portion are then extruded by the mating module along the first guide surface and the second guide surface, respectively, to elastically deform outward along the second direction; the first contact portion and the second contact portion then cross the first guide surface and the second guide surface, respectively, so as to be in electrical contact with the first contact pad and the second contact pad, respectively.

12. The connector assembly according to claim 11, wherein the constriction portion comprises a first flat surface and a second flat surface disposed opposite to the first flat surface along the second direction;
the base portion comprises a third flat surface and a fourth flat surface disposed opposite to the third flat surface along the second direction;
the first guide surface connects the first flat surface and the third flat surface; and the second guide surface connects the second flat surface and the fourth flat surface.

13. The connector assembly according to claim 12, wherein the first guide surface smoothly connects the first flat surface and the third flat surface; the second guide surface smoothly connects the second flat surface and the fourth flat surface.

14. The connector assembly according to claim 13, wherein a first arc is provided and used for transition between the first guide surface and the first flat surface; a second arc is provided and used for transition between the first guide surface and the third flat surface; a third arc is provided and used for transition between the second guide surface and the second flat surface; and a fourth arc is provided and used for transition between the second guide surface and the fourth flat surface.

15. The connector assembly according to claim 12, wherein a distance between the third flat surface and the fourth flat surface along the second direction is greater than a distance between the first flat surface and the second flat surface along the second direction.

16. The connector assembly according to claim 12, wherein the constriction portion comprises a first guide inclined surface and a second guide inclined surface which are disposed at an end of the constriction portion; the first guide inclined surface and the second guide inclined surface are configured to abut against the first contact portion and the second contact portion, respectively.

17. The connector assembly according to claim 11, wherein the housing comprises a first conductive housing and a second conductive housing; the first conductive housing and the second conductive housing are separately arranged and fixed together to jointly form the receiving slot;
the first conductive terminals are not in contact with the first conductive housing; the second conductive terminals are not in contact with the second conductive housing.

18. The connector assembly according to claim 17, wherein the electrical connector further comprises a first ground sheet fixed to the first conductive housing; the first ground sheet comprises a first mounting plate, a second mounting plate disposed opposite to the first mounting plate, and a first connecting plate connecting one side of the first mounting plate and one side of the second mounting plate; the second mounting plate is provided with a first ground elastic arm protruding into the receiving slot and being configured to abut against the mating module.

19. The connector assembly according to claim 17, wherein the electrical connector comprises a second ground plate fixed to the second conductive housing; the second ground plate comprises a third mounting plate, a fourth mounting plate disposed opposite to the third mounting plate, and a second connecting plate connecting one side of the third mounting plate and one side of the fourth mounting plate; the fourth mounting plate is provided with a second ground elastic arm protruding into the receiving slot and being configured to abut against the mating module.

20. The connector assembly according to claim 11, wherein the electrical connector comprises a plurality of first cables connected to the first conductive terminals and a plurality of second cables connected to the second conductive terminals.
